(19) United States
(12) Patent Application Publication
(10) Pub. No.: US 2006/0031086 A1
(43) Pub. Date: Feb. 9, 2006

(54) System and method for providing a virtual mailbox

(76) Inventors: Michael D. Miles, Portland, OR (US); Ron Wiener, Portland, OR (US)

Correspondence Address: PERKINS COIE LLP;PATENT-SEA, P.O. BOX 1247, SEATTLE, WA, 98111-1247, US

(21) Appl. No.: 11/195,491

(22) Filed: Aug. 1, 2005

Related U.S. Application Data
(60) Provisional application No. 60/592,648, filed on Jul. 30, 2004.
(60) Provisional application No. 60/619,367, filed on Oct. 15, 2004.
(60) Provisional application No. 60/626,571, filed on Nov. 9, 2004.

(51) Int. Cl. G06Q 99/00

(52) U.S. Cl. 705/1; 705/26

(57) ABSTRACT

Aspects of the invention are directed toward the centralized reception and processing of documents and the presentation of electronic representations of those documents to the document owners. For example, certain embodiments of the invention are directed toward a method of providing a virtual mailbox that includes providing a menu of disposition options electronically via a network to a remote user for disposition of materials having contents. The method can further include receiving instructions from the user relating to disposition of the materials and receiving the materials with contents intended for a remote user. The method can further include obtaining an image of the contents and storing the image of the contents. The method can still further include providing an image of the contents electronically via the network in a virtual mailbox accessible by the remote user, storing the contents in a storage location, and applying the disposition rules to the contents.

### CROSS-REFERENCE TO RELATED APPLICATIONS

This non-provisional application claims the benefit of and priority to provisional U.S. Patent Application No. 60/592,648, filed Jul. 30, 2004, provisional U.S. Patent Application No. 60/619,367, filed Oct. 15, 2004, and provisional U.S. Patent Application No. 60/626,571, filed Nov. 9, 2004, all of which are incorporated herein in their entirety by reference thereto.

### TECHNICAL FIELD

This document describes the centralized reception and processing of documents and the presentation of electronic representations of those documents to the document owners.

### BACKGROUND

Sending, transporting, receiving, copying, storing and destroying paper documents is costly to individuals, businesses and the environment. Regulatory requirements (Sarbanes-Oxley, HIPPAA, etc.) continue to add to the cost of paper documents. The “paperless office” concept has been with us since the mid-1970's, but has for various reasons never come to fruition.

One of the last remaining sources of paper documents is postal mail. The Document Command Postal Mail and Archive Document Process receives postal mail and archive pouches, identifies the owner, creates an electronic representation of the contents and provides for destruction or archival of the paper original.

### SUMMARY

The present invention provides a system and method for providing a centralized reception and processing of documents to provide a virtual mailbox that overcomes drawbacks experienced by the prior art and provides other benefits.

### BRIEF DESCRIPTION OF THE DRAWINGS

FIG. 1 is a schematic flow chart showing a process in accordance with an embodiment of the present invention.

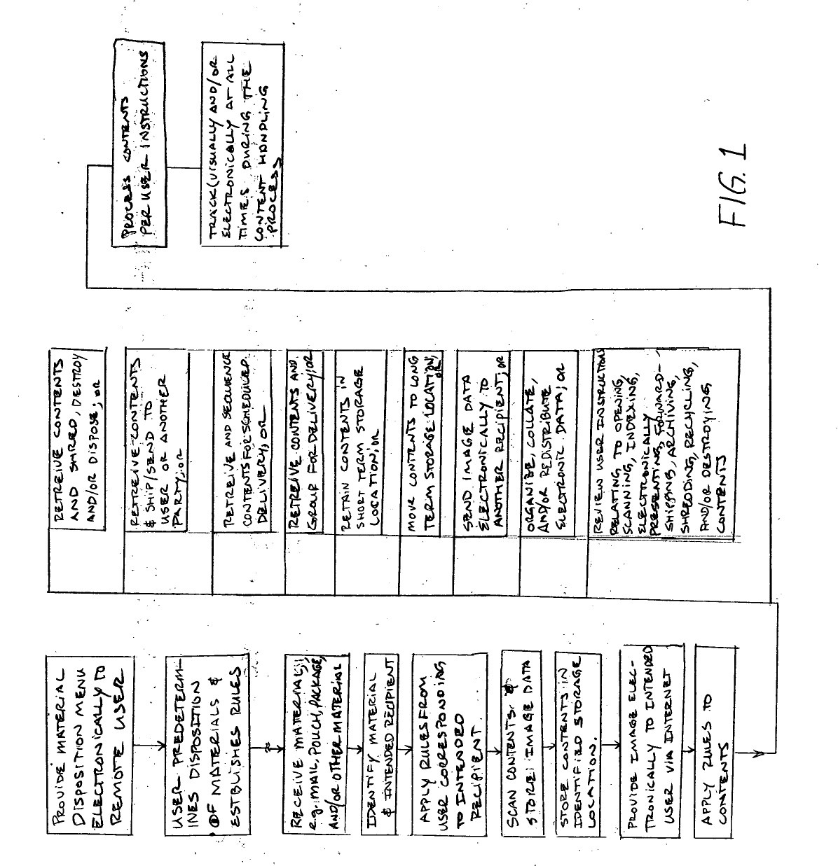

### DETAILED DESCRIPTION

Our next-generation intelligent megasorter improves post office efficiency:
Reduction in labor, OCR equipment and real estate costs.
Combines letter, flat, overnight letter and small parcels into a single mail stream (everything except large parcels).

The advanced sortation methodology that results from a sortation, scanning, handling, and processing system that has been explained in related documents, including document attached as Appendix A. In summary, the system permits all or some portion of the mail in inventory, whether immediately inserted or resident for some period of time, to be selectively retrieved in such a manner that the order of the mail is compatible and to the best advantage of later operations performed with or to the mail. Such operations may include but are not limited to the delivery order, sequencing the mail for scheduled shipment, or immediate retrieval of specific mail pieces without having to process the entire batch, tray, or inventory as required by the existing systems.

Virtual Mailboxes create new postal revenue sources from Internet-connected customers
Level I: See if you have any important mail waiting—customers can see the mail accumulating in their “inbox,” before it is delivered.
Level II: Order your mail to be delivered anywhere—allow items to be grouped for delivery on more convenient dates, or forward-shipped to anywhere else in the world.
Level III: Read your mail instantly from anywhere in the world—by remote control customers can order specific letters to be opened and have their contents scanned into TIFF or PDF format, then emailed to them or downloaded from the web.
Fewer “last mile” deliveries
Reduced cost of undeliverable mail
More “grouping” of deliveries

As described in the referenced document, the system can be used for re-routing, re-direction, intercepting, and re-distribution of the mail or its contents via the physical and/or via electronic means.

Eliminate the last external source of paper from the enterprise, such as a business-to-business enterprise. The operation of a typical business involves receiving and processing various forms of inbound communication and documents. Such forms are typically either verbal via telephones or like technology, electronic via fax, email, or other forms of file transfer, or paper via the postal mail or other shipping/receiving operations. The system and its control and operations as described here remove the requirement of the physical material to actually be deposited or delivered to the recipient company. The conversion to electronic form is not specifically unique however the ability to effectively organize, collate, and redistribute the electronic form in the same manner as mail or other paper-based items is specific, novel, and distinct from other current systems. The paper-based items may be but are not limited to document files, archives, illustrations, artwork, and the like.

Present electronic images of postal mail to recipients. The system as described provides a distribution of the electronic content to individuals regardless of their ability to receive the physical articles. The system provides its services for the distribution of postal content to any postal mail recipient that has a computer and an Internet connection.

Recipient determines the disposition of incoming postal mail:
Open, scan, index and electronically present contents
Forward ship to another postal address
Archive
Recycle
Shred

As described in related documents, the system includes a data management process which tracks and allows the user to perform a variety of functions on the mail they have received. Such functions serve to provide the user complete control over the disposition of the mail in the same manner they would have when receiving the mail physically. One aspect of the system is to provide the ability to distribute the images in a secure manner using the existing infrastructure of the Internet.

Recipient can also predetermine the disposition of incoming archival pouches:
Open, scan, index and electronically present (or deliver) contents
Copy
Forward Ship
Archive
Recycle
Shred

As described in related documents, the system includes a data management process which tracks and allows the user to perform a variety of functions on the archival pouches they have received. Such functions serve to provide the user complete control over the disposition of the pouch contents in the same manner they would have when receiving the pouches physically. The unique nature of this invention is to provide the ability to distribute the images in a secure manner using the existing infrastructure of the Internet.

System “Learns” to Recognize Mail Pieces via Optical Character Recognition (OCR), Forms Matching and Pattern Matching.

The system may include hardware and/or software for processing the digital images such that the format or specific patterns of the image may be recognized for other uses. Such uses may include but are not limited to address blocks, iconography, graphics, text and/or numeric blocks associated to forms with varied information entered in them, and other content that is associating unique entry information to a standardized structure or format.

Post Processing Mail Piece Images after Initial Real-Time Image Capture to Improve OCR Results by Eliminating the Real-Time Constraints of Mail Sorting Equipment.

The system is configured such that images may be processed for recognizable content at the time of capture, or at a later time determined by but not limited to system configuration, processing load, or related resources. Delayed processing of the images is unique to this particular embodiment of the system such that additional computing and/or operator resources may be brought to bear on the processing for greater accuracy and/or efficiency in generating the resulting data files.

Integrating Customer Name and Address Database Information into OCR Processing to Improve OCR Results by Bounding the Possible OCR Solution Set.

The processing of an image for character recognition is further enhanced for speed and accuracy in the circumstances when the database information regarding the range of expected content can be accessed and used for comparison and/or verification purposes to determine the image content.

System Automatically Applies Recipient-Specified Rules to Process Recognized or Unrecognized Mail Pieces without Further Recipient Intervention.

The system may include the ability to provide processing of mail pieces and/or its contents in the circumstance when the recipient of the content has previously specified a disposition or set of processes to be applied to the content. This feature enables the system to take action in the absence of the user or recipient. This permits a greater system efficiency in processing content during off-peak periods of operation.

System Automatically Applies Recipient-Specified Rules to Process Archival Pouches without Further Recipient Intervention.

The system may include the ability to provide processing of the pouch or its contents in the circumstance when the recipient of the content has previously specified a disposition or set of processes to be applied to the pouch or its contents. This feature enables the system to take action in the absence of the user or recipient. This permits a greater system efficiency in processing content during off-peak periods of operation.

System Automatically Applies Recipient-Specified Rules to Process Mail Pieces Based on the Sender without Further Recipient Intervention.

The system may include the ability to provide processing of a mail piece and its contents in the circumstance when the recipient of the content has previously specified a disposition or set of processes to be applied to the mail piece or its contents. This feature enables the system to take action in the absence of the user or recipient. This permits greater system efficiency in processing content during off-peak periods of operation.

Sealed Pouches for Archival Document Transport and Storage Eliminates Invasion of Privacy Concerns.

The system is configured to accept pieces which may be delivered in conventional mail materials and/or in a pouch. A pouch is configured to be an envelope of a specific size that is compatible with the machinery and mechanisms of the system. The pouch may be but is not required to be capable of containing one or more pages of paper or similarly flat material. The size of the pouch may be determined by the size and quantity of the materials to be inserted in it. There are several sizes that may be defined for convenient handling and containment of standardized formats of paper such as legal, letter, or any of various other common form factors. The pouch may include but is not required to have a closure such as adhesive or other attachment means. The closure is intended to provide the user a measure of confidence that the contents of the pouch are protected and secure from casual, inadvertent, or intentional access by person(s) that are not intended or permitted to access the contents. Such a seal on the pouch also provides an indication that the pouch security has been compromised if the intended recipient receives a pouch that does not have a secure seal or closure on it.

Electronically tracking the location of each document at all times after induction minimizes document loss, enables time-based video monitoring of each document and provides a complete forensic trail for each document.

The system shall have a multitude of strategically placed electronic monitoring devices to provide tracking, observation, and location information of the material while it is within the facility. Such devised may include but are not limited to cameras with still or video images, RFID monitoring, and barcode devices. The collected information from such devices regarding any particular item of material in the system may provide useful information in the event the material does not arrive at its intended location or the pouch seal indicates the contents may have been accessed by unauthorized observers.

Presentation of Time-Based Video Monitoring of Each Document to the Document's Owner Eliminates Security Concerns.

The accumulation of the tracking, observation, and location information may be provided to the owner, recipient, or other authorized individual or group for the material such that they may determine what events transpired during the system handling of the material.

Single Click Change of Address Capability.

The system provides the capability to track the companies and individuals that send postal mail to a recipient at a particular address and to automatically generate change of address notices to those senders when the recipient's postal mail address changes.

Recipients can manage the flow of unsolicited advertising mail. The system allows a recipient to perform any or all of the various following functions:
Identify advertising mailers to the system.
Generate requests to advertising mailers to remove one or more recipients at a postal address from a mailing list and verify that the request is received and acted upon by the advertising mailer as required by postal regulations.
Generate reminder requests at specific time intervals to advertising mailers who do not act upon earlier requests.
Generate requests to credit reporting bureaus to prevent the selling of name and address information.
Specify any number of preference categories for advertising mail they wish to receive.
Automatically generate change of address notices to selected advertising mailers. See “single click change of address capability”, above.

An additional capability of the system includes its use as a tool to optimize or otherwise benefit the direct mail industry in whole or in part. The direct mail industry relies on mailing lists and other sources to build and maintain their databases of target or potential customers. The entries in such a database may include individuals or businesses that are no longer interested in the particular purposes of the direct mail management function. Current processes for recipients to be removed from the mailing list range from awkward to non-existent. Such recipients do not typically respond or purchase from the direct mail campaign however they typically do not remove themselves from the distribution lists. The system as described permits the advertising mailers to improve their response rate (and revenue flow) from mailings. The system builds a preference list that can be rented by an advertising mailer to determine:
Recipients who have indicated an interest in an advertising mailer's product. Adding the names of recipients who've indicated an interest in the mailer's product to the mailing list improves return on investment by including high-probability responders in the mailing list).
Recipients who have indicated no interest in an advertising mailer's product. Removing the names of recipients who don't want the mailer's product from the mailing list improves return on investment by eliminating low-probability responders from the mailing list.

I/We claim:

1. A method of providing a virtual mailbox, comprising:
provide menu of disposition options electronically via a network to a remote user for disposition of materials having contents;
receive instructions from the user relating to disposition of the materials;
receiving the materials with contents intended for a remote user;
obtain an image of the contents;
store the image of the contents;
provide an image of the contents electronically via the network in a virtural mailbox accessible by the remote user;
store the contents in a storage location; and
apply the disposition rules to the contents.

2. The method of claim 1, wherein applying the disposition rules includes at least one of: shred the contents, recycle the contents, sequence the contents for scheduled delivery, group the contents for delivery, retain contents in short-term storage location, retain contents in long-term storage; and send image data to another recipient.

3. The method of claim of claim 1 electronically and visually tracking the contents during processing of the contents.
